(19) United States
(12) Patent Application Publication
(10) Pub. No.: US 2017/0113213 A1
(43) Pub. Date: Apr. 27, 2017

(54) CATALYST PARTICLE AND METHOD FOR PRODUCING THEREOF

(71) Applicant: Canatu Oy, Helsinki (FI)

(72) Inventors: David P. Brown, Helsinki (FI); Olivier Reynaud, Kauniainen (FI); Anton Sergeevich Anisimov, Espoo (FI); Albert G. Nasibulin, Espoo (FI)

(21) Appl. No.: 15/317,717

(22) PCT Filed: Jun. 8, 2015
(86) PCT No.: PCT/FI2015/050399

§ 371 Date: Dec. 9, 2016

(30) Foreign Application Priority Data
Jun. 9, 2014 (FI) 20145530

(51) Int. Cl. B01J 31/02; B01J 35/02; B01J 19/06; B01J 37/04; B01J 37/00; B01J 13/00; B01J 23/745; B01J 35/12

(52) U.S. Cl. CPC B01J 31/0215; B01J 23/745; B01J 35/026; B01J 35/12; B01J 37/04; B01J 37/0072; C01B 31/0246; C01B 31/0233; B01J 13/0095; B01J 19/06; B82Y 40/00

(57) ABSTRACT

A method for producing catalyst particles is disclosed and includes forming a solution including a solvent and a material including catalyst material, wherein the material including catalyst material is dissolved or emulsified in the solvent; aerosolizing the formed solution to produce droplets including the material including catalyst material; and treating the droplets to produce catalyst particles or intermediate catalyst particles from the material including catalyst material comprised in the droplets. A method for producing nanomaterials, an apparatus, a catalyst particle and a solution droplet for the production of a catalyst particle are also disclosed.

### FIELD OF THE INVENTION

The present invention relates to micro- and nano-scale particles and methods of production thereof. More particularly, the invention relates to catalyst particles and methods of production thereof.

### BACKGROUND OF THE INVENTION

Nanomaterials comprise a wide range of structures and morphologies including films, platelets, spheres and even more complex shapes such as nanocubes, nanocones and nanostars. Many of these nanomaterials can be produced in catalytic reactions involving catalyst particles of a given composition different from the target nanomaterial. A special subclass of these catalytically produced nanomaterials are High Aspect Ratio Molecular Structures (HARMs) such as carbon nanotubes (CNTs), Carbon NanoBuds (CNBs), Silver Nanowires (AgNWs) and other nanotube, nanowire and nanoribbon type structures. Transparent and conductive and semiconducive thin films based on HARMs are important for many applications, such as transistors, printed electronics, touch screens, sensors, photonic devices, electrodes for solar cells, lightning, sensing and display devices. Thicker and porous HARM films are also useful for e.g. fuel cells and water purification. For transparent electrode applications, among the main advantages of HARM thin films over existing ITO thin layers are their improved flexibility with similar transparency. Carbon supplies are also cheaper and more easily available than indium supplies.

Catalyst production processes known in the art generally include physical vapor nucleation for aerosol catalyst production and reduction of oxides in solid solutions for CVD catalyst production. In particular, methods such as evaporation of solutions already comprising pre-made catalyst particles have been used to produce catalyst particles in the gas phase. However, the processes known in the art produce catalyst particles with often unpredictable shapes, sizes and other poorly controlled properties. Catalyst particles known in the art include nickel, cobalt and iron particles.

### SUMMARY OF THE INVENTION

In this section, the main embodiments of the present invention as defined in the claims are described and certain definitions are given.

According to a first aspect of the present invention, a method for producing catalyst particles is disclosed. The method comprises: forming a solution comprising a solvent and a material including catalyst material, wherein the material including catalyst material is dissolved or emulsified in the solvent; aerosolizing the formed solution to produce droplets comprising the material including catalyst material; and treating the droplets to produce catalyst particles or intermediate catalyst particles from the material including catalyst material comprised in the droplets.

A solution is here understood to mean any combination of one or more ingredients wherein at least one ingredient is in liquid, gel, slurry, or paste form. According to the invention a solvent includes materials that disperse a material in the liquid phase. Thus, included in solvents are, for instance, emulsifiers. A solvent may be selected from, for instance, the group of 1,1,2-Trichlorotrifluoroethane, 1-Butanol, 1-Octanol, 1-Chlorobutane, 1,4-Dioxane, 1,2-Dichloroethane, 1,4-Dioxane, 1-Methyl-2-pyrrolidinone, 1,2-Dichlorobenzene, 2-Butanol, 2,2,2-Trifluoroethanol, 2-Ethoxyethyl ether, 2-Methoxyethanol, 2-Methoxyethyl acetate, Acetic acid, Acetic anhydride, Acetonitrile (MeCN), Acetone, Benzene, Butyl acetate, Benzonitrile, Carbon tetrachloride, Carbon disulfide, Chloroform, Chlorobenzene, Citrus terpenes, Cyclopentane, Cyclohexane, Dichloromethane, Diethyl ether, Dichloromethane (DCM), Diethyl ketone, Dimethoxyethane, Dimethylformamide (DMF), Dimethyl sulfoxide, Deuterium oxideAcetone, Diethyl amine, Diethylene glycol, Diethylene glycol dimethyl ether, Dimethyl sulfoxide (DMSO), Dimethylformamide (DMF), Ethanol, Ethyl acetate, Ethylene glycol, Formic acid, Glycerin, Hexane, Heptane, Hexamethylphosphorus triamide, Hexamethylphosphoramide, Isopropanol (IPA), Isobutyl alcohol, Isoamyl alcohol, m-Xylene, Methanol, Methyl isobutyl ketone, Methyl ethyl ketone, Methylene chloride, Methyl Acetate, Nitromethane, n-Butanol, n-Propanol, Nitromethane, N,N-Dimethylacetamide, o-Xylene, p-Xylene, Pentane, Petroleum ether, Petrol ether, Propylene carbonate, Pyridine, Propanoic acid, Tetrahydrofuran (THF), Toluene, Turpentine, Triethyl amine, Tert-butyl methyl ether, Tert-butyl alcohol, Tetrachloroethylene, and water. Other solvents are possible according to the invention.

A catalyst material is here understood to broadly cover all materials in gaseous, liquid, solid or any other form that can be used to catalyze the growth of nanomaterials. Examples include, but are not limited to metals such as iron, nickel, molybdenum, cobalt, platinum, copper, silver or gold and mixtures or compounds containing them (e.g. carbides, nitrides, chlorides, bromides, sulfates, carbonyls and oxides).

The produced catalyst can be in an intermediate state, i.e. intermediate catalyst particles. This refers to a state in which the particles are essentially without solvent but not yet activated for catalysis.

According to an embodiment, if intermediate catalyst particles are produced, the method further comprises treating the intermediate catalyst particles to produce catalyst particles.

A material including catalyst material refers to both the material comprising the catalyst and catalyst precursors or catalyst sources, and is here understood to broadly cover all materials in gaseous, liquid, solid or any other form, which, when treated or processed, produce either catalyst material in gaseous, liquid or solid form and/or catalyst particles or catalyst materials. In addition, catalyst materials and catalyst sources having surfactants on their surfaces to allow dispersion by e.g. solvation or emulsification, in the solvent are hereby considered materials including catalyst material according to the invention unless otherwise stated.

By “material is dissolved” is meant that the material or ions thereof spread out and become surrounded by solvent molecules.

By “emulsified” is here meant that a mixture of two or more liquids that are normally immiscible (nonmixable or unblendable) is created.

Aerosolizing the formed solution to produce droplets and treating the droplets to produce catalyst particles provides the technical effect of control over various properties of the produced catalyst particles such as their size, shape, morphology and composition. For instance, if a larger catalyst particle is required, aerosolization parameters may be chosen so that larger droplets are produced which directly affects the size of the resulting catalyst particle. Conversely, if a smaller catalyst particle is required, solvent parameters may be chosen such that a less catalyst material exists per droplet which directly affects the size of the resulting catalyst particle.

According to an embodiment, the formed solution has a viscosity between 0.0001 Pascal Seconds (Pa S) and 10 Pa S, preferably between 0.0001 Pa S and 1 Pa S. In some instances, the suitable viscosity is a function of the aerosolization method and the preferred solution droplet size.

As it is clear to a skilled person, the solution may have any viscosity that is beyond the above ranges. A viscosity within the 0.0001 Pa S-10 Pa S can be advantageously low for the solution to be aerosolizable by means used in the present invention.

According to an embodiment, the solution comprises 10-99.9 weight-percent of solvent, and preferably 90-99 weight-percent of solvent.

According to an embodiment, the solution comprises 0.01-50 weight-percent of material including catalyst material, and preferably 0.1-4 weight-percent of material including catalyst material.

As it is clear to a skilled person, the solution may comprise any weigh-percent of solvent and material including catalyst material which are beyond the above ranges.

According to an embodiment, the method further comprises adding a promoter in order to produce catalyst particles comprising at least part of the promoter.

A promoter is here understood to cover all materials in gaseous, liquid, solid or any other form which promote, accelerate, or otherwise increase or improve the nucleation or growth rate of nanomaterials or aid in controlling one or more properties of the nanomaterial to be produced. Examples of a promoter include, but are not limited to, sulfur, selenium, tellurium, gallium, germanium, phosphorous, lead, bismuth, oxygen, hydrogen, ammonia, water, alcohols, thiols, ethers, thioethers, esters, thioesters, amines, ketones, thioketones, aldehydes, thioaldehydes, and carbon dioxide. For the purpose of this invention, promoter precursors are considered promoters. For example, in the case of the promoter sulfur, compounds such as thiophene, ferrocenyl sulfide, solid sulfur, carbon disulfide, thiophenol, benzothiophene, hydrogen disulfide, dimethyl sulfoxide, which are precursor to or sources of the promoter sulfur, are herein termed promoters.

The promoter may be added in the solution, introduced during or after aerosolization or during treatment. According to an embodiment of the invention, the promoter is present in the solution before aerosolization, though the promoter may be added or introduced later in the process. The technical effect of the promoter being present in the solution is that its concentration relative to the solvent and material including catalyst material can be more exactly controlled.

According to an embodiment, aerosolizing the solution to produce the droplets is carried out by spray nozzle aerosolization, air assisted nebulization, spinning disk atomization, pressurized liquid atomization, electrospraying, vibrating orifice atomization, sonication, ink jet printing, spray coating, spinning disk coating, and/or electrospray ionization. As it is clear to a skilled person, the solution may be aerosolized by other means according to the invention.

According to an embodiment, treating the droplets to produce catalyst particles is carried out by heating, evaporation, thermal decomposition, sonication, irradiation and/or chemical reaction. Chemical reaction may comprise adding a reagent to cause a chemical transformation inside the particle. Chemical reaction or thermal decomposition can also be used to release the material from the precursor.

According to an embodiment, the material including catalyst material is selected from a group consisting of organometallic compounds and metal organic compounds. Other materials including catalyst material are possible according to the invention. Materials including catalyst materials can be prone to release the catalyst material during the droplet treatment, for instance, through chemical reaction or thermal decomposition.

Examples of such compounds include, but are not limited to, molybdenum hexacarbonyl, ferrocene, iron pentacarbonyl, nickelecene, cobaltocene, tetracarbonyl nickel, iodo(methyl)magnesium MeMgI, diethylmagnesium, organomagnesium compounds such as iodo(methyl)magnesium MeMgI, diethylmagnesium (Et2Mg), Grignard reagents, methylcobalamin hemoglobin, myoglobin organolithium compounds such as n-butyllithium (n-BuLi), organozinc compounds such as diethylzinc (Et2Zn) and chloro(ethoxycarbonylmethyl)zinc (ClZnCH2C(═O)OEt) and organocopper compounds such as lithium dimethylcuprate (Li+[CuMe2]—), metal beta-diketonates, alkoxides, and dialkylamides, acetylacetonates, metal alkoxides, lanthanides, actinides, and semimetals, triethylborane (Et3B).

The method of any of the above embodiments can be used in the catalytic synthesis of a nanomaterial.

According to a second aspect of the invention, a method is disclosed. The method comprises: forming a solution comprising a solvent and a material including catalyst material, wherein the material including catalyst material is dissolved or emulsified in the solvent; aerosolizing the formed solution to produce droplets comprising the material including catalyst material; treating the droplets to produce catalyst particles from the material including catalyst material comprised in the droplets; introducing a nanomaterial source; and synthesizing nanomaterial from the nanomaterial source and at least one of the catalyst particles.

In an embodiment of the invention, the solvent may act as a nanomaterial source.

In an embodiment of the invention, the solvent is substantially removed from the catalyst particle or catalyst precursor particle prior to the nucleation and/or growth of the nanomaterial.

In an embodiment of the invention, the catalyst particle contains one or more catalyst materials and one or more promoters.

A nanomaterial is herein considered to be any material having a minimum characteristic length of between 0.1 and 100 nm. For instance, in the case of a nanotube or nanorod, the characteristic dimension is the diameter.

According to an embodiment, the method further comprises depositing the formed nanomaterial onto a substrate.

The substrate may be, for example, a quartz, PC, PET, PE, silicon, silicone or glass substrate.

According to an embodiment, the nanomaterial source is a carbon nanomaterial source.

A nanomaterial source is here understood to mean any material which contains any or all of the compounds or elements of which the nanomaterial consists. In the case of carbon nanomaterials, for instance, nanomaterial sources include carbon and carbon containing compounds including carbon monoxide, organics and hydrocarbons. According to the present invention, as a carbon source, various carbon containing precursors can be used. Sugars, starches and alcohols are possible carbon sources according to the invention. Carbon sources include, but are not limited to, gaseous carbon compounds such as methane, ethane, propane, ethylene, acetylene as well as liquid volatile carbon sources as benzene, toluene, xylenes, trimethylbenzenes, methanol, ethanol, and/or octanol. Carbon monoxide gas alone or in the presence of hydrogen can also be used as a carbon source.

Saturated hydrocarbons (e.g. CH4, C2H6, C3H8), systems with saturated carbon bonds from C2H2 via C2H4 to C2H6 aromatic compounds (benzene C6H6, toluene C6H5-CH3, o-xylene C6H4-(CH3)2, 1,2,4-trimethylbenzene C6H3-(CH3)3) benzene, fullerene molecules can be also used as a carbon source.

Nanomaterials comprising carbon cover a wide range of structures and morphologies including films, platelets such as graphene, spheres or spheroids such as nanoonions, fullerenes and buckyballs; fibers, tubes, rods and more complex shapes such as carbon nanotrees, nanohorns, nanoribbons, nanocones, graphinated carbon nanotubes, carbon peapods and multi-component nanomaterials such as carbon nitrogen nanotubes and carbon boron nanotubes.

According to a third aspect of the present invention, an apparatus for producing catalyst particles is disclosed. The apparatus comprises: means for aerosolizing a solution comprising a solvent and a material including catalyst material, wherein the material including catalyst material is dissolved or dispersed in the solvent, to produce droplets comprising the material including catalyst material; and means for treating the droplets to produce catalyst particles from the material including catalyst material comprised in the droplets.

In an embodiment, the apparatus further comprises means for forming a solution comprising a solvent and a material including catalyst material, wherein the material including catalyst material is dissolved or dispersed in the solvent.

In an embodiment, the apparatus further comprises means for adding a promoter in order to produce catalyst particles comprising at least part of the promoter.

According to an embodiment, the means for aerosolizing the solution to produce the droplets comprise means for spray nozzle aerosolization, air assisted nebulization, spinning disk atomization, pressurized liquid atomization, electrospraying, vibrating orifice atomization, sonication, ink jet printing, spray coating, spinning disk coating, and/or electrospray ionization.

In an embodiment, the means for treating the droplets to produce catalyst particles comprise means for heating, evaporation, thermal decomposition, irradiation, sonication and/or chemical reaction.

According to a fourth aspect of the present invention, a solution droplet for the production of a catalyst particle is disclosed. The solution droplet comprises a solvent, a material containing a catalyst material and a promoter.

According to a fifth aspect of the present invention, an apparatus for producing catalyst particles is disclosed. The apparatus comprises: an aerosolizer for aerosolizing a solution comprising a solvent and a material including catalyst material, wherein the material including catalyst material is dissolved or dispersed in the solvent, to produce droplets comprising the material including catalyst material; and a reactor for treating the droplets to produce catalyst particles from the material including catalyst material comprised in the droplets.

In an embodiment, the apparatus further comprises a mixer or stirrer for forming a solution comprising a solvent and a material including catalyst material, wherein the material including catalyst material is dissolved or dispersed in the solvent.

According to an embodiment of the invention, the solution may contain a reagent which can chemically or catalytically react with one or more components of the solution to release catalyst material from the material containing catalyst material and/or produce or activate a promoter.

Activating is here understood to mean causing a chemical or physical change so that the intended effect of the material is activated or the material is released. Examples include releasing a promoter (e.g. sulfur) from a promoter precursor (e.g. thiophene). Activation can be achieved by, for instance, chemical reaction or thermal decomposition.

An aerosolizer can also be a magnetic mixer or stirrer, a nebulizer, a droplet generator or an atomizer.

The reactor for treating the droplets may comprise a heating unit, a UV treatment unit, a chemical reaction unit, a sonication unit, a pressurizing or depressurizing unit, an irradiation unit or a combination thereof.

According to a sixth aspect of the present invention, a catalyst particle is disclosed. The catalyst particle comprises catalyst material and at least one promoter. The promoter may be selected from a group consisting of sulfur, selenium, tellurium, gallium, germanium, phosphorous, lead, bismuth, oxygen, hydrogen, ammonia, water, alcohols, thiols, ethers, thioethers, esters, thioesters, amines, ketones, thioketones, aldehydes, thioaldehydes, and carbon dioxide.

The catalyst particle may be a catalyst particle that can be used in synthesis or an intermediate catalyst particle.

The promoter can, for instance, remain inside of the particle after the production of the catalyst particle using a promoter. The catalyst particle comprising a catalyst material and a promoter can, for instance, provide increased or decreased solubility of the nanomaterial in the catalyst particle when the catalyst particle is used in nanomaterial synthesis. The technical effect of providing both the catalyst material and the promoter in the same catalyst particle is improved conversion yield, growth rate and control over nanomaterial properties.

In an embodiment, the catalyst material is selected from a group consisting of iron, nickel, cobalt, platinum, copper, silver, gold, and any combinations thereof, and any compounds which include at least one of these materials. Such compounds may include carbides, nitrides, chlorides, bromides, sulfates, carbonyls and oxides.

In an embodiment of the invention, the catalyst particle is solid.

### BRIEF DESCRIPTION OF THE DRAWINGS

FIG. 1 shows a method according to an embodiment of the present invention.

FIG. 2 shows a method according to an embodiment of the present invention.

FIGS. 3a and 3b are SEM and TEM images of nanomaterials according to an embodiment.

FIG. 4 is a diameter distribution of 60 SWCNTs.

FIG. 5 shows diameter distributions of CNTs for different sulfur concentrations according to an embodiment.

### DETAILED DESCRIPTION OF THE EMBODIMENTS

Reference will now be made to the embodiments of the present invention, examples of which are illustrated in the accompanying drawings.

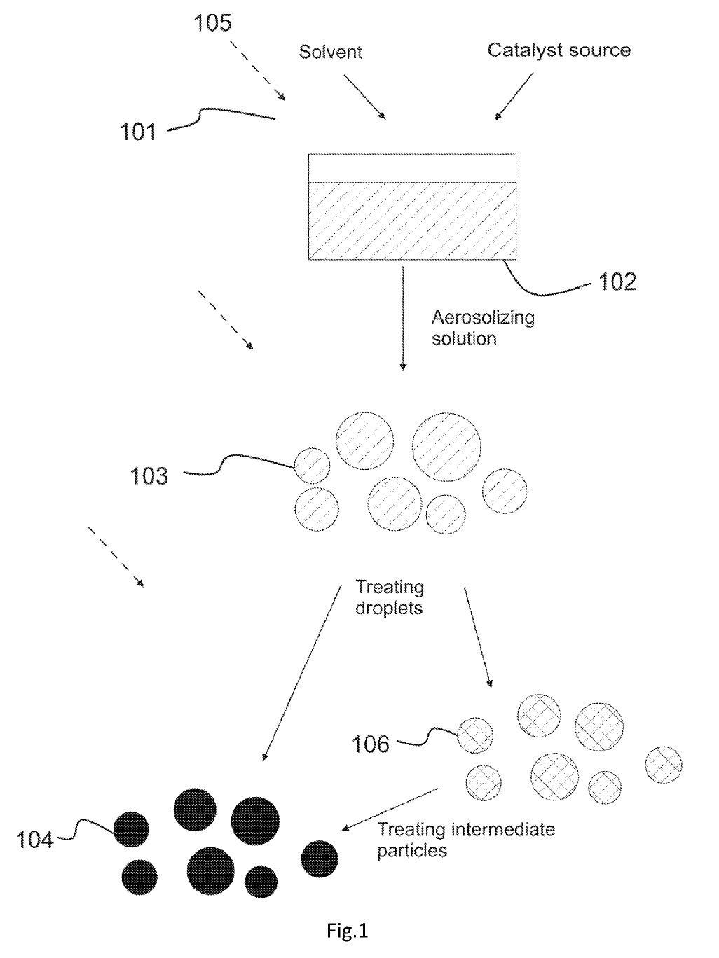

FIG. 1 shows a method according to an embodiment of the present invention. In the embodiment shown on FIG. 1, the method begins with forming a solution comprising a solvent and a material including catalyst material, indicated as step 101. A solvent and a catalyst source (material comprising catalyst material) can be added to the mixer 102 to form the solution. The catalyst source is dissolved, emulsified or otherwise dispersed in the solvent before the method continues. The solvent may be, for example, water, toluene, ethanol or any other suitable material which allows the catalyst source to become dispersed; and the catalyst source can be, for example, a compound such as ferrocene. The solution may have a viscosity between 0.0001 Pa S and 10 Pa S, preferably between 0.0001 Pa S and 1 Pa S. Such viscosity can allow for efficient aerosolization of the solution. The solution can comprise 10-99.9 weight-percent of solvent, and preferably 90-99.9 weight-percent of solvent. It can also have 0.001-90 weight-percent of catalyst source, and preferably 0.01-50 weight-percent of the catalyst source and more preferably 0.1 to 5 weight-percent of the catalyst source. The above range of ratios can provide for efficient catalyst material production at different conditions.

The solution is then aerosolized to produce droplets 103 comprising the catalyst source. This can be done, for example, by spray nozzle aerosolization, air assisted nebulization or atomization. The droplets 103 comprising the catalyst source may be of different size depending on the conditions of the aerosolization. They may also have a distribution of sizes. Preferably, the standard deviation of the droplet size distribution is below 5 and more preferably below 3 and more preferably below 2 and more preferably below 1.5 percent. In an embodiment, the aerosol size distribution is monodisperse.

In an embodiment of the invention, in the absence of droplet or particles agglomeration or coagulation, each droplet of solution results in a catalyst particle. Reactor conditions such as temperature, solution, carbon source and carrier gas feed rates, solvent, material containing catalyst material, promoter weight fractions in solution, level of turbulence, reactor configuration or geometry, classification or pre-classification of droplet or catalyst particles, loading of droplets or catalyst particles and pressure can be varied to minimize collisions in the gas phase leading to agglomeration and coagulation. Other means of controlling collisions are possible according to the invention.

In an embodiment, the droplets 103 are treated to produce catalyst particles 104. This can be done e.g. by heating, evaporation, thermal decomposition, sonication, irradiation and/or chemical reaction. During the treatment the solvent may evaporate from the droplets 103. The catalyst particles 104 are produced from the catalyst source, i.e. catalyst material is released from the material comprising catalyst material and catalyst particles are formed.

In an alternative embodiment, the catalyst material is not fully released from the material containing catalyst material and intermediate catalyst particles 106 are formed. In this case the solvent is removed but the catalyst material may not be released from the material comprising catalyst material. The intermediate particles 106 can be further treated to release the catalyst material from the material containing catalyst material. This way, catalyst particles 104 can also be formed.

The method can also include an optional step of adding a promoter 105, shown by dashed arrows. The promoter 105 may be introduced at any moment during the production of catalyst particles, i.e. added to the solution in the mixer 102, introduced during aerosolization or during treatment. The promoter may increase or improve the growth rate of nanomaterials when the produced catalyst particle is used for producing nanomaterials, or aid in controlling one or more property of the nanomaterial to be produced. An example of the promoter is thiophene.

In one embodiment, the promoter material is not released from the promoter precursor and an intermediate promoter particle is formed (not shown on FIG. 1).

Production rates, quality control and yield of nanomaterials are a function of the efficiency of material conversion and uniformity and composition of catalyst particles. Since certain properties of nanomaterials are dependent on the properties of their catalyst particles during synthesis, the nanomaterials produced by this method can have controllable properties. For example, in the case of HARMs such as CNT and CNBs, diameter of the nanomaterial, is directly related to the catalyst diameter.

Therefore, the size and other properties of the catalyst particles 103 produced by the above method can be controlled by selecting different aerosolization and treatment techniques and conditions. Since the catalyst particles are not produced from pre-made catalyst material but are produced from a catalyst source dissolved, emulsified or otherwise dispersed in the solvent, their properties do not depend on the properties of the pre-made material, and conditions can be chosen such that they are not likely to agglomerate before they are produced in the gas phase.

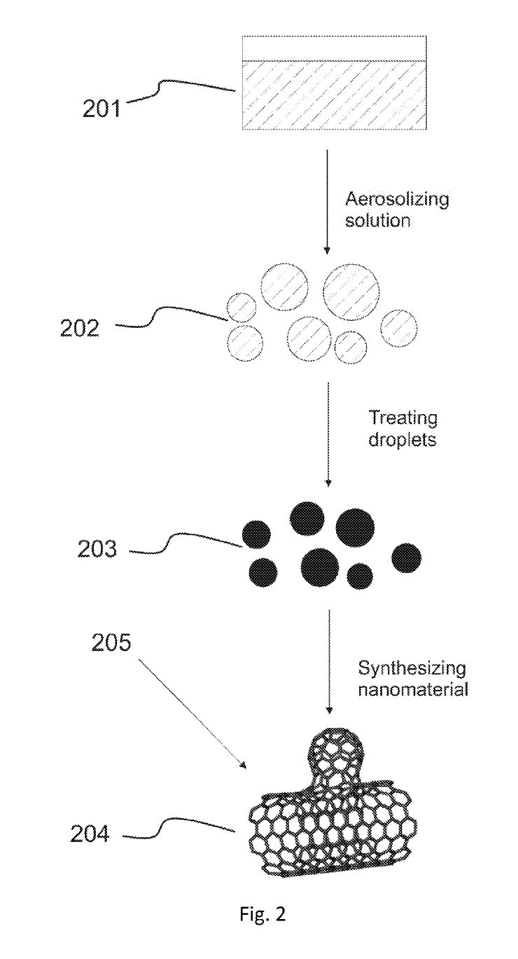

FIG. 2 shows a method for synthesizing nanomaterials according to an embodiment of the present invention. The method, similarly to the method shown on FIG. 1, can start with forming a solution 201 comprising a solvent and a catalyst source which is dissolved, emulsified or otherwise distributed therein. Then the solution 201 is aerosolized to produce droplets 202 comprising catalyst source, then the droplets are treated and catalyst particles are produced. After this, nanomaterial 204 is synthesized. The nanomaterial may be a carbon nanomaterial, such as a carbon nanotube or a carbon nanobud (shown on FIG. 2).

For the synthesis of nanomaterial 204, a nanomaterial source 205 needs to be introduced, as shown by the arrow in FIG. 2. The nanomaterial source 205 may be introduced at any point during this method, and in the example shown on FIG. 2 it is introduced during synthesis of nanomaterial 204. In the case of carbon nanomaterials, nanomaterial sources 205 can include carbon and carbon containing compounds including carbon monoxide, carbohydrates and hydrocarbons. A solvent can also act as a nanomaterial source, for instance, once the solvent is substantially evaporated from the droplets.

A promoter may also be added at any moment during the method shown on FIG. 2. The promoter can aid in synthesis of nanomaterial 204, accelerate it or provide control over certain properties of the nanomaterial 204.

According to the invention, catalyst material, material containing catalyst material or promoters may be dispersed by solvation, emulsification, through the use of surfactants or by any other means to disperse them in the solvent.

In an embodiment of the invention, before the nanomaterial is nucleated or catalytically synthesized from the catalyst particle, the solvent can be removed, e.g. by evaporation or chemical reaction, so that one or more of the catalyst materials, material containing catalyst materials and, if present, promoters are no longer in solution, emulsified or otherwise dispersed in the solvent. Consequently, the catalyst can be in a solid, liquid or molten state. According to the invention, the particle can be further treated, e.g. by adding energy or through chemical reaction to release the catalyst material and/or the promoter from a promoter precursor so that they become activated.

According to one embodiment of the invention, it is possible to store the liquid, solid or molten catalyst particles in an intermediate state (i.e. in a state essentially without solvent but before they are activated for catalysis) for later dispersion in an aerosol reactor or deposition on a substrate for surface supported growth of a nanomaterial.

According to one embodiment of the invention, the liquid, solid or molten final catalyst particles or intermediate catalyst particles are stored on a substrate or in a secondary solution where they be dispersed, for instance, by means of a surfactant to be later aerosolized into a nanomaterial synthesis reactor or coated on a substrate.

In an embodiment of the invention, the catalyst particles or intermediate catalyst particles are immediately used while in the carrier gas to produce nanomaterials or are immediately further treated while in the carrier gas to produce catalyst particles which are immediately used while in the carrier gas to produce nanomaterials and, thus, are not collected and stored on a substrate or in solution for later use.

The synthesized nanomaterial 204 may be subsequently deposited onto a substrate (not shown).

### EXAMPLE

In one embodiment of the current invention, a catalyst precursor material (ferrocene) and a promoter (thiophene) were dissolved into a solvent (toluene) to form a liquid feedstock (the solution including solvent and catalyst source), which was then atomized by a nitrogen (the carrier gas) jet flow to produce aerosol droplets. In this example, toluene was also a nanomaterial (in this case carbon) source. This aerosol was continuously carried into the reactor through a stainless steel tube by high flow rate (8 lpm) of a second promoter (hydrogen (H2)). Other gaseous reactants (carbon sources ethylene (C2H4) and carbon dioxide (CO2)) were introduced and mixed with the gas flow as desired. Gaseous reactant flows were measured and controlled by mass flow controllers. Other nanomaterial sources, solvents, promoters, carrier gases, reactor materials and configurations, and flow rates are possible according to the embodiments of the invention.

Catalyst particles (in this case, iron, though other catalyst particles are possible according to the invention) were obtained by conditioning the droplets (in this example, by thermal decomposition of ferrocene), followed by growth of iron atom clusters in the furnace. Other means of producing catalyst particles and other catalyst materials and precursors are possible according to the invention. The reactor was a 5 cm diameter quartz tube heated by a split tube furnace, which has a 60 cm long hot zone. Other reactor materials, means of introducing energy and geometries are possible according to the invention.

CNT (carbon nanotube) synthesis was then performed at various temperatures including 1100 ° C. The synthesis was performed at atmospheric pressure in laminar flow conditions inside the reactor, though other pressures and flow conditions (e.g. turbulent or transitional flow) are possible according to the invention. Any other pressure is possible according to the invention. CNTs were collected at the reactor outlet by an 11 cm diameter nitrocellulose filter (Millipore, 0.45 μm diameter pores). Other collection means are possible according to the invention including direct thermophoretic, inertial, gravitational and electrophoretic deposition. Residence time in the reactor was about 2 seconds. Other residence times are possible according to the invention to allow sufficient time for growth but limit agglomeration or exhaustion of carbon sources.

The aerosol number size distribution was measured with electrostatic differential mobility analyzer (TSI model 3071) and condensation particle counter (TSI model 3775). In order to measure optical absorption spectrum and transmittance (measured at 550 nm) of CNT thin films, CNTs were transferred from nitrocellulose filter to 1 mm thick quartz substrate (Finnish glass), and the spectrum was recorded by UV-vis-NIR absorption spectrometer (Perkin-Elmer Lambda 950). For TEM observation, CNTs were deposited directly on copper TEM grids (Agar Scientific lacey carbon mesh) by putting them on the collection filter at the outlet of the reactor. High resolution TEM images were recorded with double aberration-corrected JEOL JEM-2200FS. SEM images were recorded by a Zeiss Sigma VP microscope. Raman spectra were recorded with HORIBA Jobin Yvon LabRAM HR 800 spectrometer and 633 nm HeNe laser. Sheet resistance was measured with a 4-point linear probe (Jandel 4 point-probe, Jandel Engineering Ltd).

Aerosol droplets comprising catalyst source produced by the atomizer had a geometric mean diameter of 72.4 nm, and a logarithmic standard deviation of 1.7. In the preferred operation of this embodiment, aerosol particle precursor droplets are formed by an atomizer, though other means of generating an aerosol from a feed stock which are known in the art may be employed. The atomizer allowed generation of aerosol of well-defined size distribution and concentration, which can be tuned by changing the atomizing nitrogen flow.

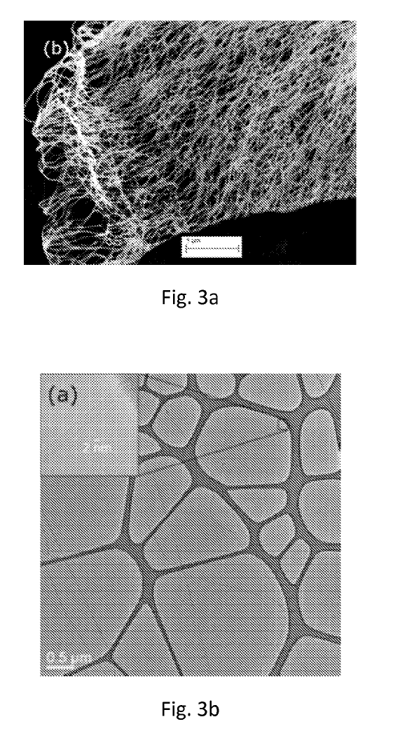

In an exemplary embodiment, temperature used for synthesis was set to 1100° C. At that temperature, films peeled off easily from the filter, and were successfully transferred by dry transfer technique on Polyethylene terephthalate (PET), glass and quartz substrates. SEM (FIG. 3a) and TEM (FIG. 3b) images show long CNTs and a clean network.

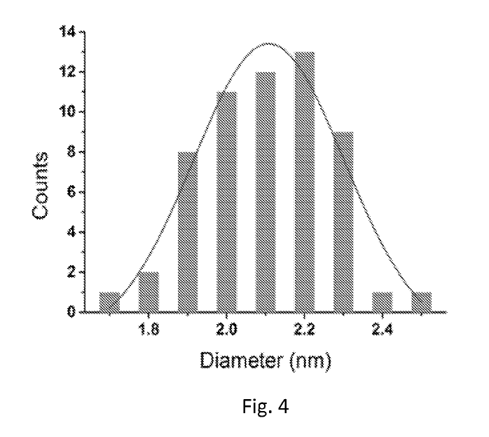

Only small amounts of side products could be observed on CNT walls. The diameter distribution obtained by diameter measurement of 60 SWCNTs (single-walled carbon nanotubes) is shown on FIG. 4. The average diameter calculated from those measurements is 2.1 nm.

The feedstock was prepared with a ferrocene concentration between 0.5% wt. and 4% wt., and good optoelectronic performances for CNT films were obtained with the lowest ferrocene concentration tried (0.5% wt. ferrocene in feedstock). When the concentration of ferrocene was increased, the synthesis rate of CNT films of certain transmittance increased, but so did the sheet resistance. Ferrocene concentration of 0.5% wt. was selected for the rest of the exemplary embodiment.

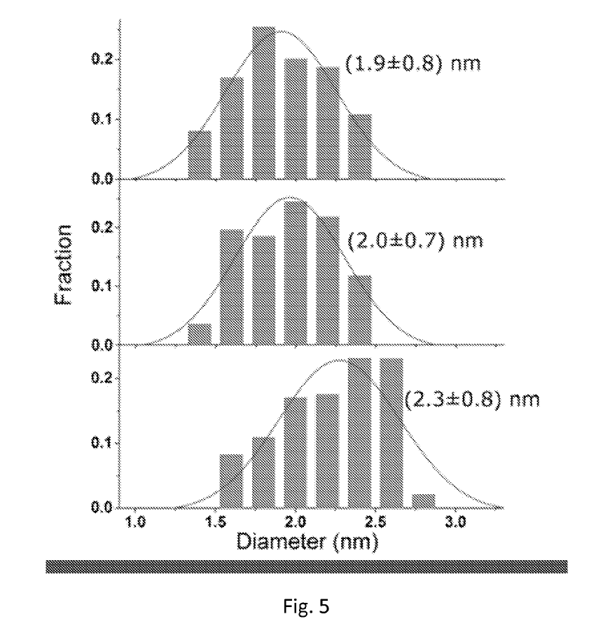

Thiophene was introduced in the reactor as sulfur containing promoter for CNT growth. Various syntheses with different thiophene concentrations in the liquid feedstock have been performed: the molar ratio of sulfur over iron (S/Fe) was varied between 0 and 4:1. To investigate the effect of sulfur concentration change on the diameter distribution, optical absorption spectroscopy which allows direct estimation of whole CNT diameter distribution was used. It was observed that sulfur slightly changes the CNT diameter distribution. A Gaussian fitting of diameter distributions was performed to obtain the mean diameter of CNT for different sulfur concentration (FIG. 5). The diameter increased from 1.9 to 2.3 nm with S/Fe atomic ratio increasing from 1:1 to 4:1.

The effect of ethylene concentration has been investigated by fabricating various CNT samples with different flows of ethylene as carbon source (from 4 sccm to 100 sccm). As collection time of CNTs at the outlet of the reactor was the same for all the samples, it could be observed that introducing more ethylene into the reactor increased the yield of the synthesis, and also slightly decreased CNT distribution diameter.

It is obvious to a skilled person that with the advancement of technology, the basic idea of the invention may be implemented in various ways. The invention and its embodiments are thus not limited to the examples described above; instead they may vary within the scope of the claims.

1. A method for producing catalyst particles, characterized in that the method comprises:
forming a solution comprising a solvent and a material including catalyst material, wherein the material including catalyst material is dissolved or emulsified in the solvent,
aerosolizing the formed solution to produce droplets comprising the material including catalyst material, and
treating the droplets to produce catalyst particles or intermediate catalyst particles from the material including catalyst material comprised in the droplets.

2. The method of claim 1, wherein intermediate catalyst particles are produced, the method further comprising: treating the intermediate catalyst particles to produce catalyst particles.

3. The method of any one of claims 1 and 2, wherein the formed solution has a viscosity between 0.0001 Pascal Seconds and 10 Pascal Seconds, preferably between 0.0001 Pascal Seconds and 1 Pascal Seconds.

4. The method of any one of claims 1 to 3, wherein the solution comprises 10-99.9 weight-percent of solvent, and preferably 90-99.9 weight-percent of solvent.

5. The method of any one of claims 1 to 4, wherein the solution comprises 0.01-50 weight-percent of material including catalyst material, and preferably 0.1-4 weight-percent of material including catalyst material.

6. The method of any one of claims 1 to 5, wherein the method further comprises adding a promoter in order to produce catalyst particles comprising at least part of the promoter.

7. The method of claim 6, wherein the promoter is added to the solution comprising a solvent and a material including catalyst material.

8. The method of any one of claims 1 to 7, wherein aerosolizing the solution to produce the droplets is carried out by spray nozzle aerosolization, air assisted nebulization, spinning disk atomization, pressurized liquid atomization, electrospraying, vibrating orifice atomization, sonication, ink jet printing, spray coating, spinning disk coating, and/or electrospray ionization.

9. The method of any of claims 1 to 8, wherein treating the droplets to produce catalyst particles is carried out by heating, evaporation, thermal decomposition, sonication, irradiation and/or chemical reaction.

10. The method of any of claims 1 to 9, wherein the material including catalyst material is selected from a group consisting of organometallic compounds and metal organic compounds.

11. Use of the method of any one of claims 1 to 10 in catalytic synthesis of nanomaterial.

12. A method of for producing nanomaterial, characterized in that the method comprises:
forming a solution comprising a solvent and a material including catalyst material, wherein the material including catalyst material is dissolved or emulsified in the solvent,
aerosolizing the formed solution to produce droplets comprising the material including catalyst material,
treating the droplets to produce catalyst particles from the material including catalyst material comprised in the droplets,
introducing a nanomaterial source, and
synthesizing nanomaterial from the nanomaterial source and at least one of the catalyst particles.

13. The method of claim 12, wherein the method further comprises depositing the formed nanomaterial onto a substrate.

14. The method of any one of claims 12 and 13, wherein the nanomaterial source is a carbon nanomaterial source.

15. An apparatus for producing catalyst particles, characterized in that the apparatus comprises:
means for aerosolizing a solution comprising a solvent and a material including catalyst material, wherein the material including catalyst material is dissolved or dispersed in the solvent, to produce droplets comprising the material including catalyst material, and
means for treating the droplets to produce catalyst particles or intermediate catalyst particles from the material including catalyst material comprised in the droplets.

16. The apparatus of claim 15, further comprising means for forming a solution comprising a solvent and a material including catalyst material, wherein the material including catalyst material is dissolved or dispersed in the solvent.

17. The apparatus of any one of claims 15 and 16, wherein the apparatus comprises means for adding a promoter in order to produce catalyst particles comprising at least part of the promoter.

18. The apparatus of any one of claims 15 to 17, wherein the means for aerosolizing the solution to produce the droplets comprise means for spray nozzle aerosolization, air assisted nebulization, spinning disk atomization, pressurized liquid atomization, electrospraying, vibrating orifice atomization, sonication, ink jet printing, spray coating, spinning disk coating, and/or electrospray ionization.

19. The apparatus of any one of claims 15 to 18, wherein the means for treating the droplets to produce catalyst particles comprise means for heating, evaporation, thermal decomposition, irradiation, sonication and/or chemical reaction.

20. A solution droplet for the production of a catalyst particle comprising a solvent, a material containing a catalyst material and a promoter.

21. The solution droplet of claim 20, wherein the catalyst material is selected from a group consisting of iron, nickel, cobalt, platinum, copper, silver, gold, and any combinations thereof, and any compounds which include at least one of these materials.

22. A catalyst particle, characterized in that the catalyst particle comprises catalyst material and at least one promoter.

23. A catalyst particle of claim 22, wherein the promoter is selected from a group consisting of sulfur, selenium, tellurium, gallium, germanium, phosphorous, lead, bismuth, oxygen, hydrogen, ammonia, water, alcohols, thiols, ethers, thioethers, esters, thioesters, amines, ketones, thioketones, aldehydes, thioaldehydes, and carbon dioxide.

24. The catalyst particle of claim 23 wherein the catalyst material, the material containing catalyst material and the promoter are in a solid, liquid or molten state.
